(19) United States
(12) Patent Application Publication
(10) Pub. No.: US 2012/0189068 A1
(43) Pub. Date: Jul. 26, 2012

(54) ELECTRONIC TERMINALS AND METHODS USING A USB CABLE AS A RF BROADCAST SIGNAL ANTENNA

(75) Inventor: Hans Peter Körner, (US)

(73) Assignee: Sony Ericsson Mobile Communications AB

(21) Appl. No.: 13/013,105

(22) Filed: Jan. 25, 2011

(51) Int. Cl. H04L 27/00

(52) U.S. Cl. 375/259

(57) ABSTRACT

An electronic terminal includes a USB antenna interface circuit and a broadcast receiver circuit. The USB antenna interface circuit is configured to be electrically connected to at least one conductive element of a USB cable that serves as an antenna for receiving a broadcast RF signal from a remote broadcast transmitter, and is configured to extract the broadcast RF signal from a RF signal present in the at least one conductive element of the USB cable. The broadcast receiver circuit is electrically connected to the USB antenna interface circuit to receive the extracted broadcast RF signal and configured to tune to a defined station signal carried by the extracted broadcast RF signal.

### TECHNICAL FIELD

The present disclosure relates to antennas for electronic terminals and, more particularly, to electronic terminals that receive broadcast RF signals.

### BACKGROUND

Portable electronic terminals, such as mobile radios and televisions, are increasingly packing more circuitry and larger displays and keypads/keyboards within small housings. Electronic terminals that include tuners for VHF radio signals or UHF television signals typically utilize a monopole antenna whose performance is sensitive to a ratio of its length to the wavelength of the received broadcast signal. Such antennas may provide improved signal strength as the ratio increases, when the antenna length is less than the signal wavelength. However, constraints on the available space and location for the antenna can prohibit the use of a sufficient length antenna and, consequently, can negatively affect antenna performance.

### SUMMARY

In some embodiments of the present invention, an electronic terminal includes a USB antenna interface circuit and a broadcast receiver circuit. The USB antenna interface circuit is configured to be electrically connected to at least one conductive element of a USB cable that serves as an antenna for receiving a broadcast RF signal from a remote broadcast transmitter, and is configured to extract the broadcast RF signal from a RF signal present in the at least one conductive element of the USB cable. The broadcast receiver circuit is electrically connected to the USB antenna interface circuit to receive the extracted broadcast RF signal and configured to tune to a defined station signal carried by the extracted broadcast RF signal.

In some further embodiments, the USB antenna interface circuit can be configured to extract a VHF radio signal from the RF signal present in the at least one conductive element of the USB cable. The broadcast receiver circuit can be configured to tune to receive a defined radio station signal carried by the extracted VHF radio signal.

The USB antenna interface circuit can be configured to extract a VHF or UHF television signal from the RF signal present in the at least one conductive element of the USB cable. The broadcast receiver circuit can be configured to tune to receive a defined television station signal carried by the extracted UHF television signal. The television station signal can be an analog channel or digitally multiplexed channels.

The USB antenna interface circuit can be electrically connected to a conductive shield layer of the USB cable that surrounds data lines in the USB cable, and can be configured to extract the broadcast RF signal from the RF signal present in the conductive shield layer.

The USB antenna interface circuit can be electrically connected to a power supply line and/or a ground line in the USB cable, and be configured to extract the broadcast RF signal from the RF signal present in the electrically connected power supply line and/or ground line. A filter circuit element can be electrically connected to a defined one of the power supply line and the ground line and configured to at least substantially block passage of a RF signal therethrough from the defined one of the power supply line and the ground line. The USB antenna interface circuit can be electrically connected to the defined one of the power supply line and the ground line at a node between the filter circuit element and the USB cable to receive the RF signal.

The USB antenna interface circuit can include a band-pass filter that passes through a defined frequency band of the broadcast RF signal while substantially attenuating other components of the RF signal present in the at least one conductive element of the USB cable that are outside the defined frequency band. The USB antenna interface circuit can include a resonant circuit that passes through the defined frequency band of the broadcast RF signal while substantially attenuating other components of the RF signal present in the at least one conductive element of the USB cable that are outside the defined frequency band. The USB antenna interface circuit can include a passive circuit including a parallel coupled capacitor circuit element and inductor circuit element that have a circuit resonant frequency within the defined frequency band of the broadcast RF signal.

A USB data transceiver circuit can be electrically connected to data lines in the USB cable, and may not be electrically connected to any of the data lines in the USB cable.

A USB data transceiver circuit can be electrically connected to data lines in the USB cable. The USB data transceiver circuit can be further configured to control the data lines to prevent data transmission to the electronic terminal through the data lines from another electronic terminal in response to a data hold signal. The broadcast receiver circuit can be configured to regulate the data hold signal provided to the USB data receiver circuit to prevent data transmission to the electronic terminal in response to operation of the broadcast receiver circuit tuning to the defined station signal carried by the extracted broadcast RF signal. The USB data transceiver circuit can be further configured to drive at least one of the data lines to a defined value to cause an idle communication state across the USB cable in response to the data hold signal from the broadcast receiver circuit.

The electronic terminal may further include a switch circuit that selectively connects the USB antenna interface circuit to the at least one conductive element of the USB cable in response to an antenna mode signal. The broadcast receiver circuit can be configured to regulate the antenna mode signal provided to the switch circuit to connect the USB antenna interface circuit to the at least one conductive element of the USB cable while the broadcast receiver circuit is operating to tune to the defined station signal carried by the extracted broadcast RF signal, and configured to disconnect the USB antenna interface circuit from the at least one conductive element of the USB cable while the broadcast receiver circuit is not operating to tune to the defined station signal carried by the extracted broadcast RF signal. The switch circuit can be configured to electrically connect the USB antenna interface circuit to at least one of the data lines while the data hold signal provided to the USB data receiver circuit prevents data transmission through the data lines, and to electrically disconnect the USB antenna interface circuit from the at least one of the data lines while the data hold signal provided to the USB data receiver circuit allows data transmission through the data lines.

The electronic terminal may further include a USB data transceiver circuit that is electrically connected to data lines in the USB cable. A common mode filter can be electrically connected to at least two data lines in the USB cable and is configured to substantially attenuate a common component of the RF signal from the data lines while passing through data signals from the data lines.

The electronic terminal may further include a USB connector that is configured to be physically connected to a USB 2.0 or USB 3.0 compliant type of the USB cable including a pair of data lines.

Some other embodiments are directed to a method performed by an electronic terminal. The method includes receiving a RF signal from at least one conductive element of a USB cable that serves as an antenna for receiving a broadcast RF signal from a remote broadcast transmitter. The broadcast RF signal is extracted from the RF signal. A broadcast receiver circuit is tuned a defined station signal carried by the extracted broadcast RF signal.

In some further embodiments, extraction of the broadcast RF signal from the RF signal can include extracting a VHF radio signal from the RF signal present in the at least one conductive element of the USB cable, and tuning of the broadcast receiver circuit to the defined station signal carried by the extracted broadcast RF signal can include tuning to receive a defined radio station signal carried by the extracted VHF radio signal.

Extraction of the broadcast RF signal from the RF signal can include extracting a VHF or UHF television signal from the RF signal present in the at least one conductive element of the USB cable, and tuning of the broadcast receiver circuit to the defined station signal carried by the extracted broadcast RF signal can include tuning to receive a defined television station signal carried by the extracted UHF television signal.

The method may further include receiving the RF signal from at least one data line in the USB cable. The data lines can be controlled to prevent data transmission to the electronic terminal through the data lines from another electronic terminal in response to a data hold signal. The data hold signal can be regulated to prevent data transmission to the electronic terminal in response to operation of the broadcast receiver circuit to tune to the defined station signal carried by the extracted broadcast RF signal.

Other electronic terminals and methods according to embodiments of the invention will be or become apparent to one with skill in the art upon review of the following drawings and detailed description. It is intended that all such additional electronic terminals and methods be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a top view of an example electronic terminal that can use a USB cable as an antenna to receive a broadcast RF signal from a remotely located broadcast station transmitter;

FIG. 2 is an example block diagram of the electronic terminal of FIG. 1, including circuit components that use the USB cable as an antenna to receive the broadcast RF signal;

FIG. 3 illustrates an example block diagram of the USB antenna interface circuit of FIG. 2 connected to a shield layer of the USB cable to receive the broadcast RF signal;

FIG. 4 illustrates a more detailed block diagram of an example configuration of the USB antenna interface circuit of FIG. 3 and a common mode filter that filters data lines from the USB cable to attenuate the broadcast RF signal;

FIG. 5 illustrates an example block diagram of the USB antenna interface circuit of FIG. 2 connected to a ground line and/or to a power supply line of the USB cable to receive the broadcast RF signal;

FIG. 6 illustrates a further block diagram of the USB antenna interface circuit of FIG. 2 connected through a switch to at least one of the data lines of the USB cable, and further illustrates a broadcast receiver circuit that controls data transmission through the USB cable responsive to operation of the broadcast receiver circuit; and

FIG. 7 is a flowchart of operations and methods that may be carried out by the electronic terminal of FIG. 1.

### DETAILED DESCRIPTION OF EMBODIMENTS

The invention will now be described more fully hereinafter with reference to the accompanying drawings, in which embodiments of the invention are shown. This invention may, however, be embodied in many different forms and is not limited to the embodiments set forth herein.

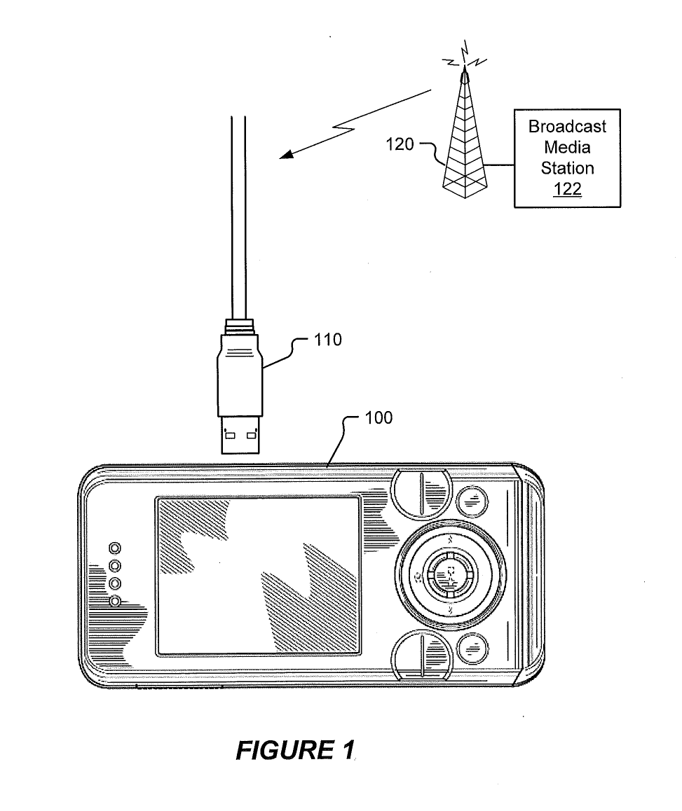

Various embodiments of the present invention may arise from the present realization that an electronic terminal can be configured to use a connected USB cable as an antenna for receiving broadcast RF signals. FIG. 1 is a top view of an example electronic terminal 100 that can be connected to a USB cable 110 which is used as an antenna to receive a broadcast RF signal from a remotely located broadcast station transmitter 120. The transmitter 120 may, for example, broadcast radio and/or television signals from a broadcast media station 122 (e.g., radio station and/or television station).

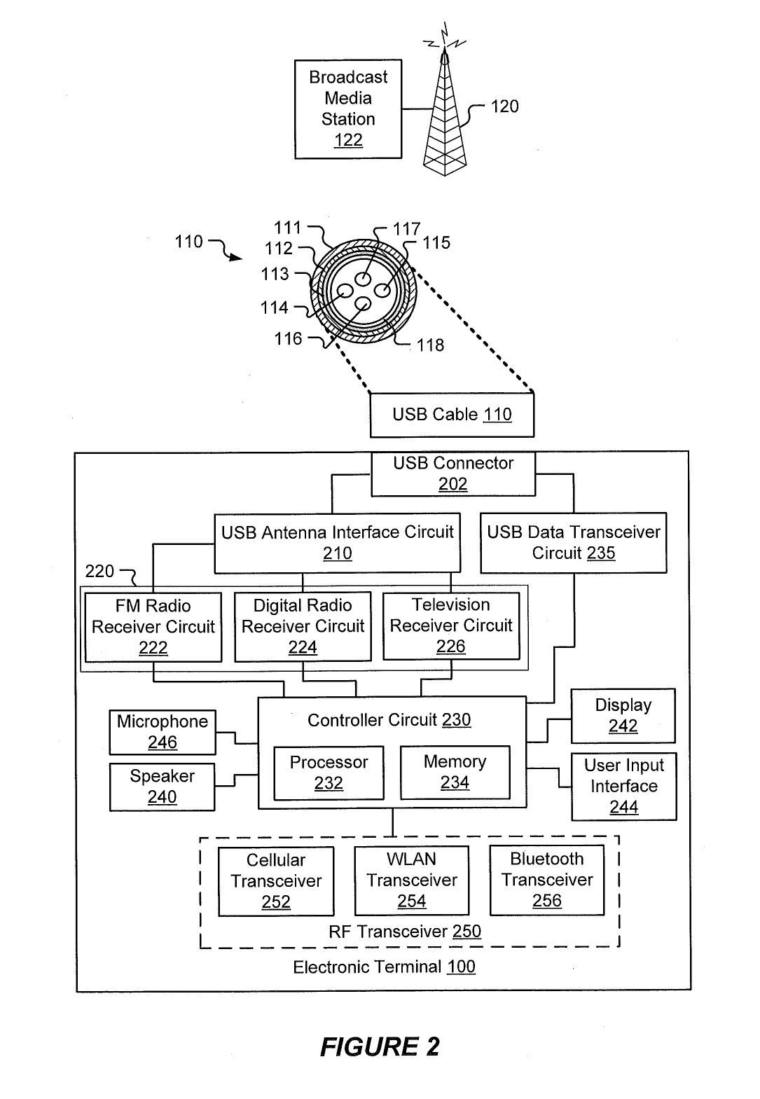

FIG. 2 is an example block diagram of the electronic terminal 100, USB cable 110, and the transmitter 120 of FIG. 1. A cross-section view of an example USB cable 110 is also shown. The cable 110 may include a PVC cover 111, a conductive braid layer 112 that strengthens the cable, a conductive shield layer 113 (e.g., aluminum, copper, tin, etc.) that at least partially shields internal conductive lines from external electrical signals, a power supply line 114 (e.g., Vcc), a ground line 115, at least two data lines 116 and 117 (e.g., D+ data line and D− data line), and may further include an insulation layer 118. The illustrated USB cable 110 power, ground, and data lines and shielding layer may be configured for compliance with the USB 2.0 and/or USB 3.0 industry standards. However, any type of USB cable may be used as an antenna to supply a RF broadcast signal according to various embodiments of the present invention. Accordingly, more or less shielding layers and/or conductive lines may be used than shown in FIG. 2.

As the shield layer 113 functions to shield the power supply line 114, the ground line 115, and the data lines 116 and 117 from the broadcast RF signals from the transmitter 120, it can also function as an antenna for the electronic terminal 100. The power supply line 114, the ground line 115, the data lines 116 and 117 may also receive the broadcast RF signal passing through, or coupled via capacitance from, the shield layer 113, such as when a shield layer 113 is not adequately grounded, and the conductive braid layer 112 can also receive the broadcast RF signal. Consequently, any conductive layer and/or line of the USB cable 110 may be used by the electronic terminal 100 as an antenna to receive the broadcast RF signal.

Because the length of the USB cable 110, which typically extends 1 to 5 meters between connectors, its conductive layers and/or lines can have a large length relative to the wavelength of the broadcast RF signal, and, therefore, can have a high antenna coupling efficiency for receiving the broadcast RF signal.

In some embodiments, electronic terminal 100 is configured to use the USB cable 110 to receive Very High Frequency (VHF) band signals (e.g., 30 MHz to 300 MHz with corresponding wavelengths of 10 m to 1 m) and/or Ultra High Frequency (UHF) signals (e.g., 300 MHz to 3 GHz with corresponding wavelengths of 1 m to 0.1 m), such as VHF radio signals and/or UHF television signals, from one or more transmitters 120.

The electronic terminal 100 includes a USB connector 202 that is configured to structurally receive the USB cable 110 and to electrically couple a USB antenna interface circuit 210 thereto. The USB connector 202 may also couple a USB data transceiver circuit 235 thereto.

The USB data transceiver circuit 235 is configured to communicate data through the data lines 116 and 117 of the USB cable 110 to another terminal that is connected to another end of the USB cable 110, and to receive data from the other terminal via the data lines 116 and 117. The transceiver circuit 235 can be a separate circuit from the antenna interface circuit 210, and may reside on a spaced apart portion of the same circuit board or may reside on a separate circuit board within the electronic terminal 100.

The USB antenna interface circuit 210 is configured to be electrically connected to at least one conductive element of the USB cable 110 that serves as an antenna for receiving the broadcast RF signal. As will be explained in further detail below, in some embodiments the USB antenna interface circuit 210 is electrically connected to the shield layer 113 to receive a RF signal therefrom, while in some other embodiments the circuit 210 is electrically connected to the conductive braid layer 112, the power supply line 114, the ground line 115, and/or one or more of the data lines 116 and 117 to receive a RF signal therefrom. The USB antenna interface circuit 210 is further configured to extract the broadcast RF signal from the RF signal which can include other undesired RF signals and electrical noise components.

The electronic terminal 100 also includes a broadcast receiver circuit 220 that is electrically connected to the USB antenna interface circuit 210 to receive the extracted broadcast RF signal, and is configured to tune to a defined station signal carried by the extracted broadcast RF signal. In one embodiment, the USB antenna interface circuit 210 is configured to extract a VHF radio signal from the RF signal, and the broadcast receiver circuit 220 includes a FM radio receiver circuit 222 and/or a digital radio receiver 224 that can be tuned to receive a defined radio station signal carried by the extracted VHF radio signal. In another embodiment, the USB antenna interface circuit 210 is configured to extract a VHF or UHF television signal from the RF signal, and the broadcast receiver circuit 220 includes a television receiver circuit 226 that can be tuned to receive a defined television station signal carried by the extracted UHF television signal.

The broadcast receiver circuit 220 can output a tuned radio station signal to other circuitry for output through a speaker 240 and/or may output a tuned television station signal to other circuitry for output through the speaker 240 and/or a display 242. In some embodiments, the electronic terminal 100 includes a controller circuit 230 that generates signaling that controls tuning by the broadcast receiver circuit 220 to receive defined radio station and/or television station signal therefrom. The controller circuit 230 may control tuning responsive to user commands that are received by a user input interface 244 (e.g. keyboard/keypad, buttons, knobs, and/or touch screen interface).

The controller circuit 230 may include a processor 232 and memory circuitry/devices 234. The processor 232 may include one or more data processing circuits, such as a general purpose and/or special purpose processor (e.g., microprocessor and/or digital signal processor). The processor 232 is configured to execute computer program instructions from the memory circuitry/devices 234, described herein as a computer readable medium, to perform some or all of the operations and methods that are described herein for one or more of the embodiments disclosed herein. Accordingly, the processor 232 can be configured by execution of the computer program instructions to carry out at least some of the functionality described herein to use the USB cable 110 as an antenna to receive a broadcast RF signal and to tune to a desired frequency (e.g., radio/television channel) within the bandwidth of the received broadcast RF signal.

The terminal 100 may include bidirectional communication circuitry, such as the illustrated RF transceiver 250, and may include a microphone 246. The RF transceiver 250 may include a cellular transceiver 252, a WLAN transceiver 254, and/or a Bluetooth transceiver 256. Accordingly, the RF transceiver 250 may communicate bi-directionally according to one or more cellular standards, such as Long Term Evolution (LTE), enhanced data rates for General Packet Radio Service (GPRS) evolution (EDGE), code division multiple access (CDMA), wideband-CDMA, CDMA2000, and/or Universal Mobile Telecommunications System (UMTS) frequency bands, according to one or more WLAN standards, and/or according to one or more Bluetooth standards.

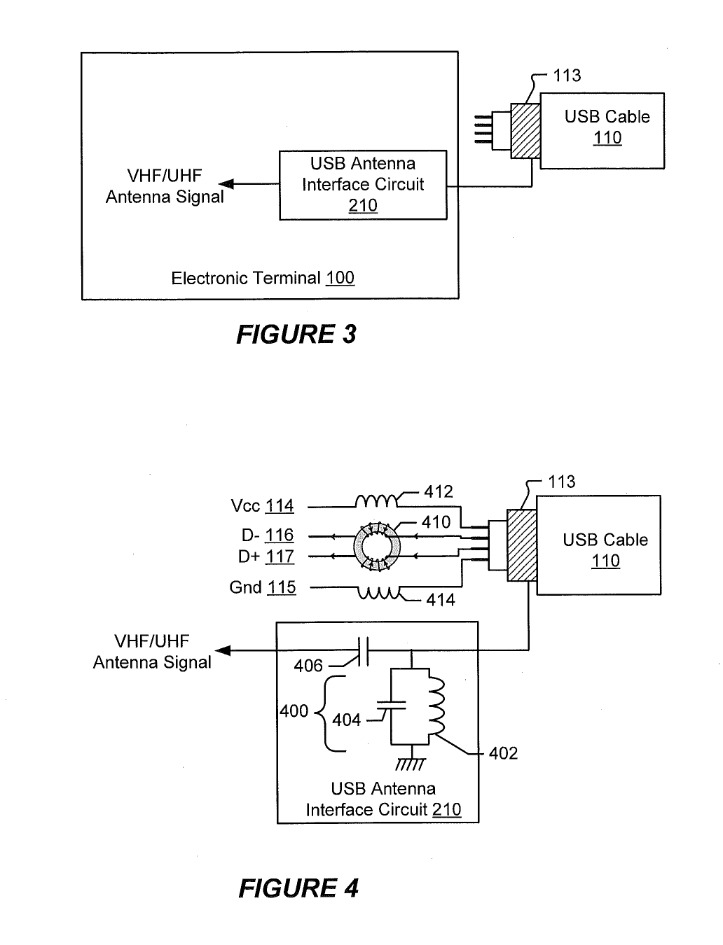

Referring to FIG. 3, an example block diagram of the USB antenna interface circuit 210 of FIG. 2 is shown that is connected to the conductive shield layer 113 of the USB cable 110 to receive the broadcast RF signal. The antenna interface circuit 210 is configured to extract the broadcast RF signal from among other RF signals present in the conductive shield layer 113 of the USB cable 110. As explained above, the antenna interface circuit 210 may be configured to extract a VHF signal, such as a frequency modulated (FM) radio signal and/or a digital radio signal, and/or a UHF signal, such as a television signal, from the RF signal conducted through the shield layer 113 which is functioning as an antenna. The antenna interface circuit 210 may be configured as a narrow bandpass filter that allows signals within a defined frequency band to pass therethrough while substantially attenuating signals outside the defined frequency band. The extracted broadcast RF signal is output to the receiver circuit 220.

Referring to FIG. 4, a more detailed block diagram of an example configuration of the USB antenna interface circuit 210 of FIG. 3 is shown. The antenna interface circuit 210 may include a resonant circuit 400 that allows signals within the defined frequency band of the broadcast RF signal to pass through while substantially attenuating other components of the RF signal received from the shield layer 113 that are outside the defined frequency band. In some embodiments, the resonant circuit 400 is a passive circuit that includes a parallel coupled capacitor circuit element 404 and inductor circuit element 402 that have a circuit resonant frequency within the defined frequency band of the broadcast RF signal. The capacitor circuit element 404 and the inductor circuit element 402 are connected in parallel to each other between a conductive pathway of the RF signal from the shield layer 113 and a ground of the electronic terminal 100. The antenna interface circuit 210 may include another capacitor circuit element 406 that is in series with the conductive pathway of the RF signal, and/or other circuit elements needed for impedance matching.

The antenna interface circuit 210 may also include a common mode filter 410 that filters the data lines 116 and 117 from the USB cable 110 to substantially attenuate a common component of the broadcast RF signal and/or other undesired RF component signals that are present in both data lines 116 and 117, while allowing data signals from the data lines 116 and 117 to pass through. The common mode filter 410 may include a magnetic core material about which the data lines 116 and 117 are wound to generate a magnetic flux therein that creates a reactive load that substantially attenuates a common component of the broadcast RF signal present in both data lines 116 and 117. The antenna interface circuit 210 may alternatively or additionally include filter circuit elements 412 and 414 (e.g., inductor circuit elements) that are each configured to at least substantially block passage of a RF signal therethrough from the connected power supply line 114/ground line 115. Alternatively, the inductors 412 and 414 can be combined as a common mode filter to minimize the influence of supply current.

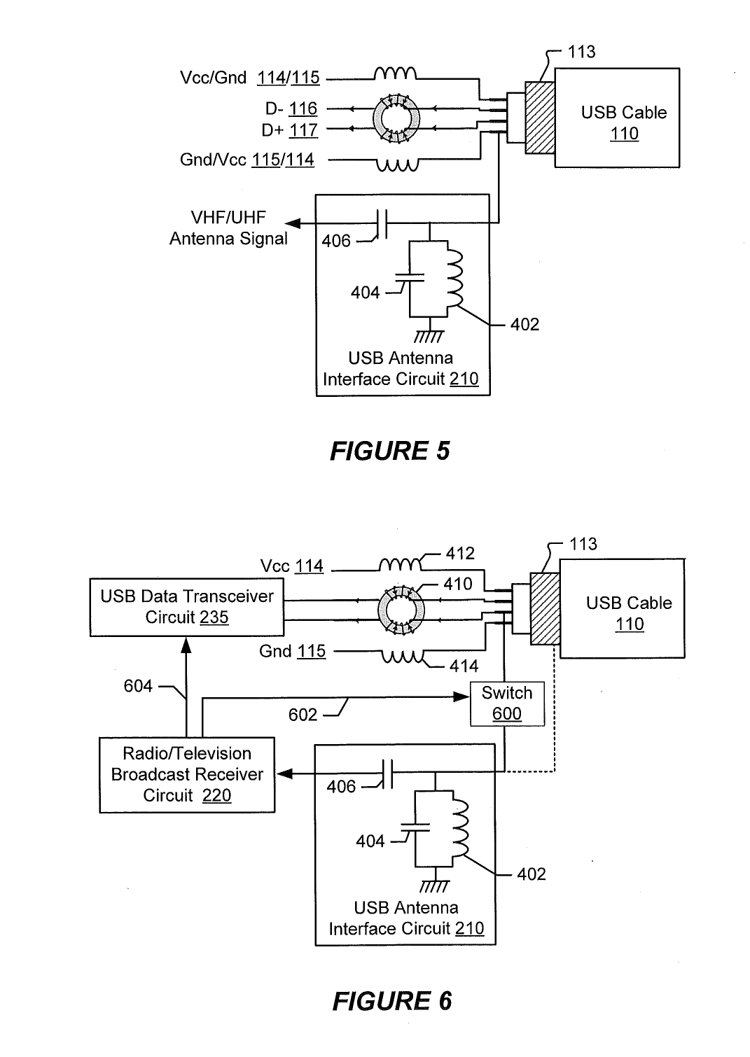

Referring to FIG. 5, another example block diagram of the USB antenna interface circuit 210 of FIG. 2 is shown that is connected to the power supply line 114 and/or the ground line 115 to receive the broadcast RF signal. The antenna interface circuit 210 is configured to extract the broadcast RF signal from among other RF signals present in the power supply line 114/ground line 115. As explained above, the antenna interface circuit 210 may be configured to extract a VHF signal, such as a frequency modulated (FM) radio signal and/or a digital radio signal, and/or a UHF signal, such as a television signal, from the RF signal conducted through the power supply line 114/ground line 115 which is functioning as an antenna. The extracted broadcast RF signal is output to the receiver circuit 220.

When the power supply line 114 and/or the ground line 115 includes the filter element 412/414, the antenna interface circuit 210 can be connected to the power supply line 114 and/or the ground line 115 at a node between the filter element and the USB cable 110 to receive the RF signal.

Referring to FIG. 6, another example block diagram of the USB antenna interface circuit 210 of FIG. 2 is shown that is connected to at least one of the data lines 116 and 117 to receive the broadcast RF signal. Various operations of the antenna interface circuit 210, the USB data transceiver circuit 235, and the receiver circuit 220 (radio/television receiver circuits 222/224/226) are now described with reference to FIGS. 2 and 6.

As explained above, the USB data transceiver circuit 235 is electrically connected to communicate through the data lines 116 and 117. The USB antenna interface circuit 210 is also connected to at least one of the data lines 116 and 117. To reduce/avoid interference that the USB antenna interface circuit 210 may cause to data communications through the connected data line(s) 116/117, the USB data transceiver circuit 210 can be configured to respond to a data hold signal 604 by controlling the data lines 116 and 117 to prevent data transmission to the electronic terminal 100 through the data lines 116 and 117 from another electronic terminal. The broadcast receiver circuit 220 can be configured to regulate the data hold signal 604 provided to the USB data receiver circuit 235 to prevent data transmission to the electronic terminal 110 in response to operation of the broadcast receiver circuit 235 being used to tune to a defined station signal carried by the extracted broadcast RF signal. The USB data transceiver circuit 235 may prevent another terminal from transmitting data through the data lines 116 and 117 by driving at least one of the data lines 116 and 117 to a defined value that causes an idle communication state across the USB cable 110 in response to the data hold signal 604.

Thus, for example, while the electronic terminal 100 is being used as a radio receiver and/or a television receiver, one or more of the data lines in the USB cable 110 can be used as an antenna to receive broadcast RF signal from the remote transmitter 120. Moreover, to reduce interference to the broadcast RF signal in the data lines, the USB data transceiver circuit 235 can cause an idle communication state in the USB cable 110 to prevent another communication terminal from transmitting data while the USB cable 110 is being used as an antenna.

Interference may also be reduced or avoided by connecting the antenna interface circuit 210 to the data line(s) 116/117 through a switch circuit 600. The switch circuit 600 selectively connects the USB antenna interface circuit 210 to data line(s) 116/117 in response to an antenna mode signal 602. The broadcast receiver circuit 220 can be configured to regulate the antenna mode signal 602 provided to the switch circuit 600 to connect the USB antenna interface circuit 210 to the data line(s) 116/117 while the broadcast receiver circuit 220 is operating to tune to the defined station signal carried by the extracted broadcast RF signal, and configured to disconnect the USB antenna interface circuit 210 from the data line(s) 116/117 while the broadcast receiver circuit 220 is not operating to tune to the defined station signal carried by the extracted broadcast RF signal.

For example, while the electronic terminal 100 is not being used as a radio/television tuner receiving a broadcast RF signal via the USB cable 110, the USB antenna interface circuit 210 may be electrically isolated from the data line(s) 116/117 to avoid interfering with data communications through the USB cable 110.

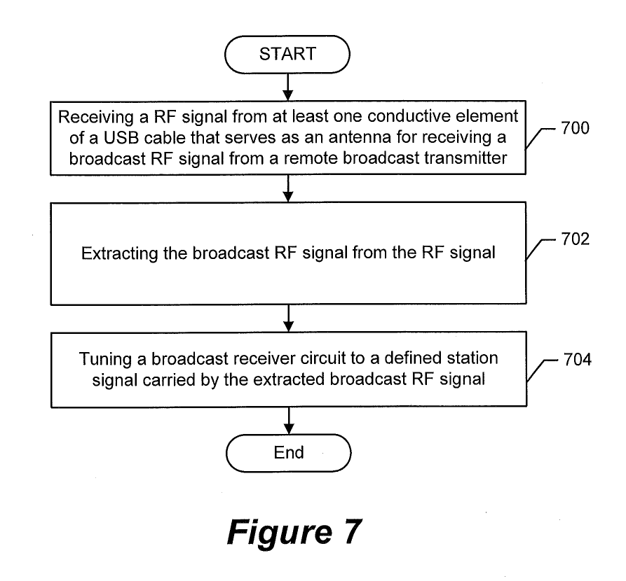

FIG. 7 is a flowchart of operations and methods that may be carried out by the electronic terminal of FIG. 1 in accordance with some embodiments. Referring to FIG. 7, a RF signal is received (block 700) from at least one conductive element of a USB cable that serves as an antenna for receiving a broadcast RF signal from a remote broadcast transmitter. The broadcast RF signal is extracted (block 702) from the RF signal. A broadcast receiver circuit, such as the receiver 220, is tuned (block 704) to a defined station signal carried by the extracted broadcast RF signal. Further operations and methods that may be carried out by the electronic terminal have been described above with regard to FIGS. 1-6 in accordance with various embodiments of the present invention.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Exemplary embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various exemplary combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed is:

1. An electronic terminal comprising:
a USB antenna interface circuit that is configured to be electrically connected to at least one conductive element of a USB cable that serves as an antenna for receiving a broadcast RF signal from a remote broadcast transmitter, and is configured to extract the broadcast RF signal from a RF signal present in the at least one conductive element of the USB cable; and
a broadcast receiver circuit that is electrically connected to the USB antenna interface circuit to receive the extracted broadcast RF signal and configured to tune to a defined station signal carried by the extracted broadcast RF signal.

2. The electronic terminal of claim 1, wherein:
the USB antenna interface circuit is configured to extract a VHF radio signal from the RF signal present in the at least one conductive element of the USB cable; and
the broadcast receiver circuit is configured to tune to receive a defined radio station signal carried by the extracted VHF radio signal.

3. The electronic terminal of claim 1, wherein:
the USB antenna interface circuit is configured to extract a VHF or UHF television signal from the RF signal present in the at least one conductive element of the USB cable; and
the broadcast receiver circuit is configured to tune to receive a defined television station signal carried by the extracted VHF or UHF television signal.

4. The electronic terminal of claim 1, wherein:
the USB antenna interface circuit is electrically connected to a conductive shield layer of the USB cable that surrounds data lines in the USB cable, and is configured to extract the broadcast RF signal from the RF signal present in the conductive shield layer.

5. The electronic terminal of claim 1, wherein:
the USB antenna interface circuit is electrically connected to a power supply line and/or a ground line in the USB cable, and is configured to extract the broadcast RF signal from the RF signal present in the electrically connected power supply line and/or ground line.

6. The electronic terminal of claim 5, further comprising:
a filter circuit element that is electrically connected to a defined one of the power supply line and the ground line and configured to at least substantially block passage of a RF signal therethrough from the defined one of the power supply line and the ground line,
wherein the USB antenna interface circuit is electrically connected to the defined one of the power supply line and the ground line at a node between the filter circuit element and the USB cable to receive the RF signal.

7. The electronic terminal of claim 1, wherein:
the USB antenna interface circuit comprises a band-pass filter that passes through a defined frequency band of the broadcast RF signal while substantially attenuating other components of the RF signal present in the at least one conductive element of the USB cable that are outside the defined frequency band.

8. The electronic terminal of claim 7, wherein:
the USB antenna interface circuit comprises a resonant circuit that passes through the defined frequency band of the broadcast RF signal while substantially attenuating other components of the RF signal present in the at least one conductive element of the USB cable that are outside the defined frequency band.

9. The electronic terminal of claim 8, wherein:
the USB antenna interface circuit comprises a passive circuit including a parallel coupled capacitor circuit element and inductor circuit element that have a circuit resonant frequency within the defined frequency band of the broadcast RF signal.

10. The electronic terminal of claim 1, further comprising:
a USB data transceiver circuit that is electrically connected to data lines in the USB cable, wherein the USB antenna interface circuit is not electrically connected to any of the data lines in the USB cable.

11. The electronic terminal of claim 1, further comprising:
a USB data transceiver circuit that is electrically connected to data lines in the USB cable,
wherein the USB data transceiver circuit is further configured to control the data lines to prevent data transmission to the electronic terminal through the data lines from another electronic terminal in response to a data hold signal; and
wherein the broadcast receiver circuit is configured to regulate the data hold signal provided to the USB data receiver circuit to prevent data transmission to the electronic terminal in response to operation of the broadcast receiver circuit tuning to the defined station signal carried by the extracted broadcast RF signal.

12. The electronic terminal of claim 11, wherein:
the USB data transceiver circuit is further configured to drive at least one of the data lines to a defined value to cause an idle communication state across the USB cable in response to the data hold signal from the broadcast receiver circuit.

13. The electronic terminal of claim 11, further comprising:
a switch circuit that selectively connects the USB antenna interface circuit to the at least one conductive element of the USB cable in response to an antenna mode signal;
the broadcast receiver circuit is configured to regulate the antenna mode signal provided to the switch circuit to connect the USB antenna interface circuit to the at least one conductive element of the USB cable while the broadcast receiver circuit is operating to tune to the defined station signal carried by the extracted broadcast RF signal, and to disconnect the USB antenna interface circuit from the at least one conductive element of the USB cable while the broadcast receiver circuit is not operating to tune to the defined station signal carried by the extracted broadcast RF signal.

14. The electronic terminal of claim 13, wherein:
the switch circuit is configured to electrically connect the USB antenna interface circuit to at least one of the data lines while the data hold signal provided to the USB data receiver circuit prevents data transmission through the data lines, and to electrically disconnect the USB antenna interface circuit from the at least one of the data lines while the data hold signal provided to the USB data receiver circuit allows data transmission through the data lines.

15. The electronic terminal of claim 1, further comprising:
a USB data transceiver circuit that is electrically connected to data lines in the USB cable;
a common mode filter that is electrically connected to at least two data lines in the USB cable and is configured to substantially attenuate a common component of the RF signal from the data lines while passing through data signals from the data lines.

16. The electronic terminal of claim 1, further comprising:
a USB connector that is configured to be physically connected to a USB 2.0 or USB 3.0 compliant type of the USB cable including a pair of data lines.

17. A method by an electronic terminal, the method comprising:
receiving a RF signal from at least one conductive element of a USB cable that serves as an antenna for receiving a broadcast RF signal from a remote broadcast transmitter;
extracting the broadcast RF signal from the RF signal; and
tuning a broadcast receiver circuit to a defined station signal carried by the extracted broadcast RF signal.

18. The method of claim 17, wherein:
extracting the broadcast RF signal from the RF signal comprises extracting a VHF radio signal from the RF signal present in the at least one conductive element of the USB cable; and
tuning the broadcast receiver circuit to the defined station signal carried by the extracted broadcast RF signal comprises tuning to receive a defined radio station signal carried by the extracted VHF radio signal

19. The method of claim 17, wherein:
extracting the broadcast RF signal from the RF signal comprises extracting a VHF or UHF television signal from the RF signal present in the at least one conductive element of the USB cable; and
tuning the broadcast receiver circuit to the defined station signal carried by the extracted broadcast RF signal comprises tuning to receive a defined television station signal carried by the extracted VHF or UHF television signal.

20. The method of claim 17, further comprising:
receiving the RF signal from at least one data line in the USB cable;
controlling the data lines to prevent data transmission to the electronic terminal through the data lines from another electronic terminal in response to a data hold signal; and
regulating the data hold signal to prevent data transmission to the electronic terminal in response to operation of the broadcast receiver circuit to tune to the defined station signal carried by the extracted broadcast RF signal.
